(19) United States
(12) Patent Application Publication
(10) Pub. No.: US 2021/0231321 A1
(43) Pub. Date: Jul. 29, 2021

(54) HEATED CABINETS, SYSTEMS INCLUDING THE SAME, AND METHODS OF USING

(71) Applicant: Joseph D. Gore, Valparaiso, IN (US)

(72) Inventor: Joseph D. Gore, Valparaiso, IN (US)

(21) Appl. No.: 17/162,946

(22) Filed: Jan. 29, 2021

Related U.S. Application Data
(60) Provisional application No. 62/967,294, filed on Jan. 29, 2020.

(51) Int. Cl. F24F 5/00; A47B 81/00

(52) U.S. Cl. CPC F24F 5/0096; F24F 2221/34; F24F 2221/10; A47B 81/00

(57) ABSTRACT

Heated cabinets suitable for storing temperature-sensitive products, systems including the same, and methods of using such systems. Such a cabinet includes walls that define a cavity therebetween, a door adapted to selectively enclose the cavity and provide access to the cavity, at least one heating element embedded within one or more of the walls or mounted to interior surfaces of one or more of the walls, and a source of electrical power for the heating element.

### CROSS REFERENCE TO RELATED APPLICATIONS

This application claims the benefit of U.S. Provisional Application No. 62/967,294 filed Jan. 29, 2020, the contents of which are incorporated herein by reference.

### BACKGROUND OF THE INVENTION

The present invention generally relates to furniture and fixtures. The invention particularly relates to cabinets with integrated heating elements.

Various items may be stored in unheated buildings and rooms or parts of buildings that are subject to damage or degradation by temperatures below freezing (0° C.). For example, consumer products such as paints, batteries, adhesives, etc., are commonly stored in garages and sheds. However, heating an entire building or even a part of a building may be unfeasible or inefficient for protecting a select few items. As such, it can be appreciated that it would be desirable if systems were available for heating or otherwise protecting temperature-sensitive products without requiring the heating of an entire building or part of a building.

### BRIEF DESCRIPTION OF THE INVENTION

The present invention provides heated cabinets suitable for storing temperature-sensitive products, systems including the same, and methods of using such systems.

According to one aspect of the invention, a cabinet is provided that includes walls that define a cavity therebetween, a door adapted to selectively enclose the cavity and provide access to the cavity, at least one heating element embedded within one or more of the walls or mounted to interior surfaces of one or more of the walls, the heating element being operable to heat the cavity and means for providing electrical power to the heating element.

According to another aspect of the invention, a system is provided that includes more than one cabinet comprising elements as described above. An electrical connector of a second cabinet can be connected to a first cabinet such that the heating element of the second cabinet is provided with electrical power from the first cabinet.

According to another aspect of the invention, a method is provided for using more than one cabinet comprising elements as described above. The method includes coupling an electrical connector of a second cabinet to a first cabinet, coupling an electrical connector of the first cabinet to an electrical outlet or cable, providing electrical power to the heating element of the first cabinet via the electrical outlet or cable and simultaneously providing electrical power to the heating element of the second cabinet via the first cabinet, and heating the cavities of the first and second cabinets with the heating elements thereof.

A technical effect of the cabinet, system, and method described above is that temperature-sensitive products may be stored within the cabinet(s) and maintained at suitable temperatures (e.g., above freezing) without the need to heat an entire building, such as a garage or shed, or other area where the products are stored.

Other aspects and advantages of this invention will be appreciated from the following detailed description.

### BRIEF DESCRIPTION OF THE DRAWINGS

FIG. 1 represents a pair of heated cabinets in accordance with certain nonlimiting aspects of the invention. Doors or the cabinets have been omitted for clarity.

FIG. 2 represents wiring within a heated cabinet in accordance with certain nonlimiting aspects of the invention.

### DETAILED DESCRIPTION OF THE INVENTION

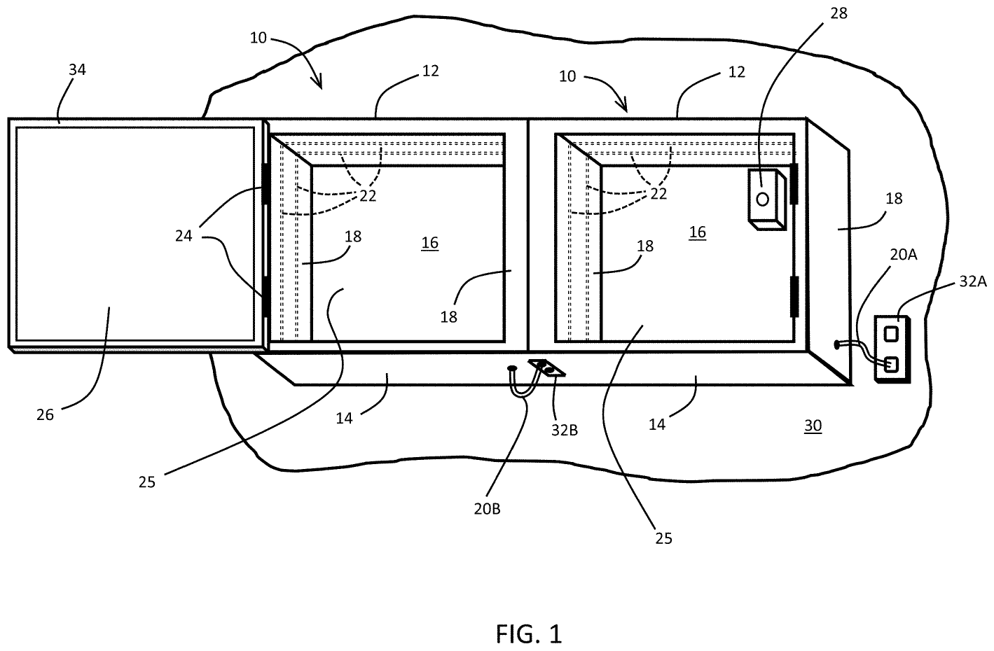

FIG. 1 represents a pair of cabinets 10 that are suitable for storing various products. The cabinets 10 are arranged in a horizontal row and each cabinet 10 includes a heating element 22 that is capable of maintaining an elevated temperature within a cavity 25 of the cabinet 10 relative to an ambient environment surrounding the exterior of the cabinet 10. Although the invention will be described hereinafter in reference to cabinets 10 of the type represented in FIG. 1, it will be appreciated that the teachings of the invention are more generally applicable to a variety of cabinets, fixtures, and containers in various locations and used for a variety of applications in which heated storage would be beneficial.

To facilitate the description provided below of the embodiment represented in the drawings, relative terms may be used to describe the cabinets 10 and their components. Relative terms including but not limited to “exterior,” “interior,” “upper,” “lower,” “front,” “rear,” “sides,” etc., and related forms thereof may also be used to describe the nonlimiting embodiment represented in the drawings. All such terms are relative to a typical installation of the cabinets 10 when used to store products as represented in the drawings, and therefore are relative terms that are useful to describe installations of the cabinets 10 represented in the drawings, but should not be necessarily interpreted as limitations to the construction, installation, operation, and use of the invention.

FIG. 1 represents a perspective view of the cabinets 10 as installed on a wall 30 next to an electrical outlet 32A, for example, within an unheated garage. The cabinets 10 represented in FIG. 1 have a construction similar to conventional wall-mounted cabinets, that is, the cabinets 10 each include an upper wall 12, a lower wall 14, a rear wall 16, and oppositely disposed side walls 18 that in combination with a front door 26 (only one of which is shown) define a generally rectangular shape that defines an internal cavity 25 defined by and between the walls 12, 14, 16, and 18 that can be completely enclosed by the door 26. For convenience of the following description, one of the doors 26 has been omitted from the drawings. It should be understood that both doors 26 may be constructed, installed, and operated as typical in the industry. For example, the front of the cabinets 10 include hinges 24 along certain edges of the side walls 18 to which the doors 26 may be pivotally coupled to allow the doors 26 to be opened and closed to provide access to the cavity 25 within each cabinet 10.

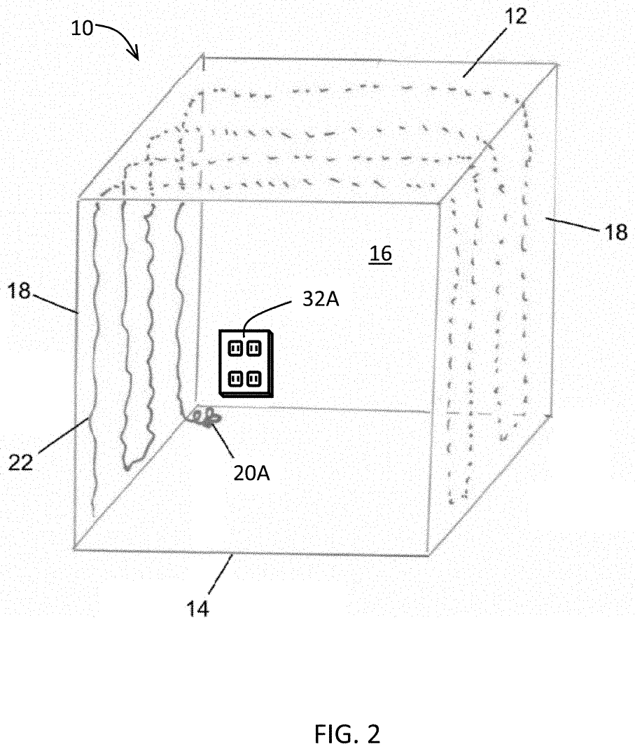

The cabinets 10 include at least one heating element 22 located on interior surfaces of one or more of the walls 12, 14, 16, and 18, or embedded within any of these walls 12, 14, 16, and 18. In FIG. 1, the heating element 22 is embedded in the walls 12, 14, and 18 of each cabinet 10. In FIG. 2, a single one of the cabinets 10 (without its door 26) is represented in which the heating element 22 is disposed on the interior surfaces of the walls 12 and 18. In each of these examples, the heating element 22 may be in the form of a single cable, for example, an electrical trace cable (e.g., heat tape) that is run in a serpentine pattern over or within the through the upper wall 12 and side walls 18. However, it should be understood that the heating element 22 may be run according to other patterns, and more than one heating element 22 could be used.

FIG. 1 represents an electrical plug 20A for electrically connecting the heating element 22 of the righthand cabinet 10 directly to the outlet 32A, and an electrical plug 20B that is plugged into an outlet 32B on the righthand cabinet 10 for electrically connecting the heating element 22 of the lefthand cabinet 10 to the heating element 22 of the righthand cabinet 10. As a result, the heating elements 22 of both cabinets 10 are powered by the electrical outlet 32A. It is also within the scope of the invention that any number of cabinets 10 may include one or more electrical plugs or connectors for providing power to heating elements 22 of any number of cabinets 10 arranged in horizontal rows and/or vertical columns. For this purpose, electrical plugs or connectors may be located on any of the cabinet walls 12, 14, 16, and 18 of a given cabinet 10.

FIG. 2 represents the electrical plug 20A of a cabinet 10 as being within the cavity 25 and attached to one end of the heating element 22 exposed in one of the side walls 18 for connection to an electrical outlet 32A mounted to the back wall 16 within the cabinet 10.

The cabinets 10 may include a control 28 (FIG. 1) to allow a user to manually control the temperature within the cabinets 10. Alternatively, the system may be self-controlled, for example, by automatically adjusting heat output based on a surface temperature adjacent the heating elements 22 or within the cavity 25 of the cabinets 10, by relying on a constant wattage, or by any other suitable means. Preferably, the heating elements 22 are capable of providing a relatively constant temperature within the cavity 25 that is above a freezing temperature or another desired temperature below which products stored in the cabinets 10 could be damaged. As an example, a heating element 22 may not engage until the temperature surrounding the cabinets 10 falls below a predetermined temperature, such as 38° F., so as to the enhance energy efficiency of the system. In addition, the cabinet doors 26 may include a seal 34 to better retain the heat generated by the heating element 22.

The cabinets 10 may be formed from one or more materials for various applications. Such materials should be capable of surviving prolonged exposure to heat produced by the heating elements 22, as well as environmental temperatures surrounding the cabinets 10. Depending on the materials from which the walls 12, 14, 16, and 18 of the cabinets 10 are formed, portions of the heating elements 22 may be insulated (for example, with a thermoplastic material) to protect the walls 12, 14, 16, and 18 of the cabinets 10 and promote heat transfer to the cavity 25. In certain embodiments, the interior surfaces of the walls 12, 14, 16, and 18 and doors 26 may be covered by an insulation layer capable of reducing heat transfer from the cavity 25 and to the exterior of the cabinet 10. Insulation is particular beneficial in embodiments in which the heating elements 22 are mounted to an interior surface of a wall 12, 14, 16, and/or 18, so that the wall is insulated from the heating element 22.

While the invention has been described in terms of specific or particular embodiments, it is apparent that alternatives could be adopted by one skilled in the art. For example, the cabinets 10 and their components could differ in appearance and construction from the embodiments described herein and shown in the drawings, functions of certain components of the cabinets 10 could be performed by components of different construction but capable of a similar (though not necessarily equivalent) function, and various materials could be used in the fabrication of the cabinets 10 and/or their components. Examples of such variations include GFCI protection, such as for electrical grounding, LED lighting, power and charging outlets, depending on the design and requirements of the cabinet system. Accordingly, it should be understood that the invention is not necessarily limited to any embodiment described herein or illustrated in the drawings. It should also be understood that the phraseology and terminology employed above are for the purpose of describing the disclosed embodiments, and do not necessarily serve as limitations to the scope of the invention. Therefore, the scope of the invention is to be limited only by the following claims.

1. A cabinet comprising:
walls that define a cavity therebetween;
a door adapted to selectively enclose the cavity and provide access to the cavity;
at least one heating element embedded within one or more of the walls or mounted to interior surfaces of one or more of the walls, the heating element being operable to heat the cavity; and
means for providing electrical power to the heating element.

2. The cabinet of claim 1, wherein the means for providing electrical power to the heating element includes at least one electrical connector configured to electrically couple with an electrical outlet or cable.

3. The cabinet of claim 1, wherein the heating element includes an electrical trace cable attached to one or more of the walls.

4. The cabinet of claim 3, wherein the cabinet includes an upper wall, a lower wall, a rear wall, and a pair of oppositely disposed side walls, and the electrical trace cable is run through the upper wall and the side walls.

5. A system comprising:
at least first and second cabinets each comprising:
walls that define a cavity therebetween;
a door adapted to selectively enclose the cavity and provide access to the cavity;
at least one heating element embedded within one or more of the walls or mounted to interior surfaces of one or more of the walls, the heating element being operable to heat the cavity; and
at least one electrical connector configured to electrically couple with an electrical outlet or cable and thereby provide electrical power to the heating element; and
means for coupling the electrical connector of the first cabinet to the second cabinet such that the heating element of the second cabinet is provided with electrical power from the first cabinet.

6. The cabinet of claim 5, wherein the heating element includes an electrical trace cable attached to one or more of the walls.

7. The cabinet of claim 6, wherein each of the cabinets includes an upper wall, a lower wall, a rear wall, and a pair of oppositely disposed side walls, and the electrical trace cable is run through the upper wall and the side walls.

8. A method comprising:
providing first and second cabinets each comprising:
walls that define a cavity therebetween;
a door adapted to selectively enclose the cavity and provide access to the cavity;
at least one heating element embedded within one or more of the walls or mounted to interior surfaces of one or more of the walls, the heating element being operable to heat the cavity; and
at least one electrical connector configured to electrically couple with an electrical outlet or cable and thereby provide electrical power to the heating element; and
coupling the electrical connector of the first cabinet to the second cabinet;
coupling the electrical connector of the first cabinet to an electrical outlet or cable;
providing electrical power to the heating elements of the first cabinet via the electrical outlet or cable and simultaneously providing electrical power to the heating element of the second cabinet via the first cabinet; and
heating the cavities of the first and second cabinets with the heating elements.
